(19) United States
(12) Patent Application Publication
(10) Pub. No.: US 2022/0170757 A1
(43) Pub. Date: Jun. 2, 2022

(54) INFORMATION PROCESSING APPARATUS, INFORMATION PROCESSING SYSTEM, INFORMATION PROCESSING METHOD AND NON-TRANSITORY STORAGE MEDIUM

(71) Applicant: TOYOTA JIDOSHA KABUSHIKI KAISHA, Toyota-shi (JP)

(72) Inventors: Yasuhiro HAYASHI, Mitaka-shi (JP); Kazunori FUJIMORI, Nagoya-shi (JP); Takuji YAMADA, Musashino-shi (JP); Naoya OKA, Nagakute-shi (JP); Daisuke KIMURA, Toyota-shi (JP); Yumiko YAMASHITA, Nagoya-shi (JP)

(73) Assignee: TOYOTA JIDOSHA KABUSHIKI KAISHA, Toyota-shi (JP)

(21) Appl. No.: 17/456,603

(22) Filed: Nov. 26, 2021

(30) Foreign Application Priority Data
Dec. 2, 2020 (JP) 2020-200470

(51) Int. Cl. G01C 21/34; G01C 21/36; G01C 21/00; G08G 1/0967; G08G 1/01

(52) U.S. Cl. CPC G01C 21/3461; G01C 21/3694; G01C 21/3415; G08G 1/0145; G08G 1/096791; G08G 1/0112; G08G 1/0129; G01C 21/3841

(57) ABSTRACT

The present disclosure provides more appropriate information for vehicles. An information processing apparatus of the present disclosure receives pieces of probe data from a plurality of vehicles having traveled through a predetermined point, each of the pieces of probe data indicating a traveling environment at the point, and generates information for other vehicles to pass through the point, for each of attributes of vehicles, based on the pieces of probe data.

### CROSS-REFERENCE TO THE RELATED APPLICATION

This application claims priority to Japanese Patent Application No. 2020-200470, filed on Dec. 2, 2020, which is hereby incorporated by reference herein in its entirety.

### BACKGROUND

### Technical Field

The present disclosure relates to a vehicle navigation technique.

### Description of the Related Art

There is a technique for deciding a traveling danger degree on a road based on probe data. For example, Japanese Patent Laid-Open No. 2007-047034 discloses an apparatus that decides a location where safety at the time of traveling is reduced, based on weather information, and generate a route bypassing the location.

[Patent document 1] Japanese Patent Laid-Open No. 2007-047034.

### SUMMARY

In an apparatus according to a conventional technique, it is uniformly decided whether traveling on a road is dangerous or not. There are various kinds of traveling hindrances that occur on roads, however, and it may not be appropriate to uniformly make a decision.

One or more aspects of the present disclosure are directed to provide more appropriate information for vehicles.

An information processing apparatus according to a first aspect of the present disclosure may include a controller comprising at least one processor, the controller being configured to execute: receiving pieces of probe data from a plurality of vehicles having traveled through a predetermined point, each of the pieces of probe data indicating a traveling environment at the point; and generating information for other vehicles to pass through the point, for each of attributes of vehicles, based on the pieces of probe data.

Further, an information processing system according to a second aspect of the present disclosure may be an information processing system including an information processing apparatus and a plurality of onboard apparatuses, wherein each of the plurality of onboard apparatuses includes a first controller comprising at least one processor, the first controller being configured to execute: generating probe data indicating a traveling environment at a predetermined point; transmitting the probe data to the information processing apparatus; and receiving map data including traveling-related information from the information processing apparatus and outputting the map data, and the information processing apparatus includes a second controller comprising at least one processor, the second controller being configured to execute: receiving the probe data from each of the plurality of onboard apparatuses; generating information for other vehicles to pass through the point, for each of attributes of vehicles, based on the probe data; generating the map data based on the information generated for a plurality of points; and transmitting the map data to the plurality of onboard apparatuses.

Further, an information processing method according to a third aspect of the present disclosure may include: receiving pieces of probe data from a plurality of vehicles having traveled through a predetermined point, each of the pieces of probe data indicating a traveling environment at the point; and generating information for other vehicles to pass through the point, for each of attributes of vehicles, based on the pieces of probe data.

Further, another aspect of the present disclosure may be a computer-readable storage medium non-transitorily storing a program for causing a computer to execute the information processing method described above.

According to the present disclosure, it is possible to provide more appropriate information for vehicles.

### BRIEF DESCRIPTION OF THE DRAWINGS

FIG. 1 is a diagram explaining an outline of a navigation system;

FIG. 2 is a diagram illustrating components of the navigation system in more detail;

FIG. 3 illustrates an example of probe data transmitted from onboard terminals;

FIG. 4 illustrates an example of a probe data table stored in a storage;

FIG. 5 illustrates an example of a danger degree table stored in the storage;

FIG. 6 is a diagram illustrating a flow of data transmitted and received among modules;

FIG. 7 is a diagram explaining danger degree information assigned to each road segment;

FIG. 8 illustrates an example of mapping of the danger degree information onto a road map;

FIG. 9 is a flowchart of a process executed by a controller 101 in a first embodiment;

FIG. 10 is a flowchart of a process executed by a controller 201 in the first embodiment;

FIG. 11 is a diagram illustrating components of a server apparatus in a second embodiment;

FIG. 12A and FIG. 12B illustrate examples of probe data and a probe data table in the second embodiment;

FIG. 13 is a diagram explaining assigned danger degree information in the second embodiment;

FIG. 14 is a diagram explaining a dangerous area in a third embodiment; and

FIG. 15 is a diagram explaining a traffic volume table in a fourth embodiment.

### DETAILED DESCRIPTION

An information processing apparatus according to an embodiment of the present disclosure may be an apparatus that generates information about traveling based on probe data transmitted from a plurality of vehicles (onboard terminals) under its management and provides the generated information for the vehicles (the onboard terminals).

The information processing apparatus may include a controller, the controller being configured to execute: receiving pieces of probe data from a plurality of vehicles having traveled through a predetermined point, each of the pieces of probe data indicating a traveling environment at the point; and generating information for other vehicles to pass through the point, for each of attributes of vehicles, based on the pieces of probe data.

The predetermined point may be a point specified by the information processing apparatus or may be a point determined by each vehicle.

The probe data is data indicating a traveling environment of each vehicle, for example, a precipitation situation, a snow cover situation, a road surface freezing situation or situations of other passage hindrances. The probe data may be generated based on sensor data acquired by a sensor mounted on each vehicle.

Based on probe data transmitted from vehicles, the information processing apparatus generates information for other vehicles to pass through a point associated with the probe data, for each of attributes of vehicles.

The attributes of vehicles may be attributes of the vehicles themselves (for example, minimum ground clearances, vehicle classes or the like) or may be equipment of the vehicles (for example, types of tires the vehicles are equipped with) or the like.

By generating information related to traveling for each attribute as described above, it becomes possible to provide appropriate information for any vehicle. For example, it becomes possible to, for a vehicle including a certain vehicle class, provide information suitable for the vehicle class.

Further, the information processing apparatus may further include a storage storing data defining a plurality of road segments, and the controller may generate the information for each of the plurality of road segments based on the pieces of probe data generated at a point corresponding to each of the plurality of road segments.

By generating the information for each road segment, it is possible to present information to drivers of vehicles in an easy-to-understand manner.

Further, the controller may determine a traveling danger degree corresponding to each of the attributes of the vehicles as the information.

Thus, information about a traveling danger degree may be generated based on probe data. By deciding a traveling danger degree for each of attributes of vehicles, it becomes possible to provide information for causing a plurality of vehicles including different attributes to safely pass on a road, for the plurality of vehicles.

Further, each of the probe data may include data about a degree of flooding at the point; and the controller may determine the traveling danger degree based on the degree of the flooding.

The data about a degree of flooding may be data obtained by directly sensing an amount of flooding or may be data for indirectly estimating the amount of flooding, such as an observed amount of precipitation.

Further, the attributes may be vehicle classes or minimum ground clearances of the vehicles; and the controller may determine the traveling danger degree for each of the vehicle classes or minimum ground clearances of the vehicles.

The minimum ground clearance is, for example, a vertical distance from a horizontal ground surface to the lowest point of a vehicle body. The vehicle classes are classifications of vehicle sizes or dimensions based on a predetermined criterion. At the time of deciding a traveling danger degree based on an amount of flooding, it is preferable to use different criteria according to vehicle classes and minimum ground clearances.

Further, each of the probe data may include data about a degree of snow cover or road surface freezing at the point; and the controller may determine the traveling danger degree based on the degree of the snow cover or road surface freezing.

The degree of snow cover or road surface freezing can be decided, for example, based on an output of an image sensor, a sensor for detecting road surface freezing, a slip detection sensor or the like mounted on each vehicle.

Further, the attributes may be types of tires that the vehicles include; and the controller may determine the traveling danger degree for each of the types of the tires that the vehicles include.

It is preferable that the types of tires are classified according to resistances to snow cover or road surface freezing.

Further, the controller may decide a first area, which is an area where a traveling danger degree in a case of a vehicle with a predetermined attribute passing through the area exceeds a threshold, and map the first area onto a road map.

The first area is an area which it is not desirable for safety for a vehicle including a predetermined attribute to enter. By mapping the first area onto a map, it is possible to inform an area not to enter, to drivers of vehicles including a predetermined attribute.

Further, the controller may predict occurrence of a first area, which is an area where a traveling danger degree in a case of a vehicle with a predetermined attribute passing through the area exceeds a threshold, and map the predicted first area onto a road map.

For example, by transmitting a mapping result to a target vehicle, it is possible to cause the vehicle to be away from the area in advance.

Further, the controller may further map a second area, which is an area to be influenced by vehicles bypassing the first area, onto the road map.

When it becomes impossible to pass through the first area, it is predicted that a traffic jam occurs due to bypassing vehicles. Therefore, by further mapping an area to be influenced by the bypassing vehicles onto the map, drivers of vehicles can select an appropriate route.

Further, the controller may further acquire data about a traffic flow of passage through the first area in the past and generate a bypass route based on the past traffic flow.

The traffic flow may be acquired, for example, for each of attributes of vehicles. Thereby, for example, it is possible to estimate how many vehicles cannot pass through the first area and how much the second area is influenced thereby.

Further, the pieces of probe data may include pieces of information about the attributes of the vehicles and pieces of information about particular behaviors that have occurred on the vehicles; and the controller may determine the traveling danger degree in a case of a plurality of vehicles with different attributes passing through the point, for each of the attributes.

Further, the particular behaviors may be slips; and the attribute may be types of tires that the vehicles include.

There may be a case where a particular behavior (a slip or the like) occurs on a vehicle due to an attribute of the vehicle (a tire type or the like). Therefore, by using pieces of information about behaviors obtained by sensing and attributes of vehicles that have performed the sensing, it is possible to appropriately determine a traveling danger degree.

Further, the pieces of probe data may include pieces of information about driving operations performed for the vehicles and pieces of information about behaviors that have occurred due to the driving operation; and the controller may determine a traveling danger degree in a case of a particular driving operation being performed.

There may be a case where a particular behavior (a slip or the like) occurs on a vehicle due to a particular driving operation (a sudden operation or the like). Therefore, by using pieces of information about behaviors obtained by sensing and driving operations performed for vehicles, it is possible to appropriately determine a traveling danger degree.

Specific embodiments of the present disclosure will be described below based on drawings. A hardware configuration, a module configuration, a functional configuration and the like described in each embodiment are not intended to limit the disclosed technical scope only to the configurations unless otherwise stated.

### First Embodiment

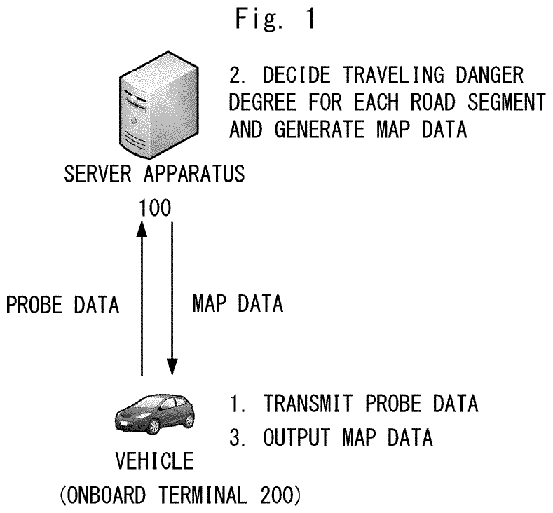

An outline of a navigation system according to a first embodiment will be described with reference to FIG. 1. The navigation system according to the present embodiment is configured, including a server apparatus 100 that generates information about a traveling danger degree on a road based on probe data acquired by vehicles, and onboard terminals 200 mounted on the vehicles.

The onboard terminals 200 are computers mounted on a plurality of vehicles under the control of the system. The onboard terminals 200 acquire, from sensors mounted on their own vehicles, data related to traveling environments of the vehicles and periodically transmit the data to the server apparatus 100 as probe data.

In the first embodiment, the onboard terminals 200 acquire data about a road surface flooding situation as the data related to traveling environments of the vehicles.

The server apparatus 100 periodically acquires probe data from the plurality of onboard terminals 200 under the management of the system, and decides traveling danger degrees of a plurality of road segments for each of attributes of the vehicles (hereinafter, vehicle attributes) based on the acquired probe data. Decision results are mapped onto the road segments and provided for the onboard terminals 200 as map data. Since the traveling danger degree is decided for each vehicle attribute, each onboard terminal 200 can provide information suitable for the attribute of its own vehicle for the driver.

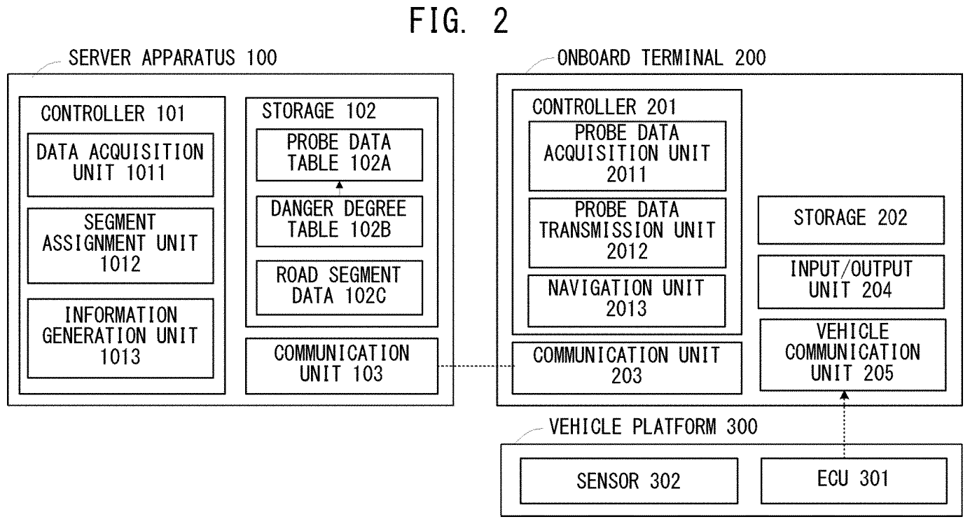

FIG. 2 is a diagram illustrating components of the navigation system according to the present embodiment in more detail.

A vehicle platform 300 is a platform including a computer that controls a vehicle. The vehicle platform 300 includes, for example, one or more computers (an ECU 301) that control the vehicle, such as an engine ECU and a body ECU, and one or more sensors 302 that can sense a traveling environment of the vehicle. In the present embodiment, a sensor that directly or indirectly senses an amount of flooding on a road surface is exemplified as the sensor 302. A sensing result is acquired by the ECU 301 and provided for the onboard terminal 200.

The onboard terminals 200 are computers mounted on vehicles. Each of the onboard terminals 200 is configured, including a controller 201, a storage 202, a communication unit 203, an input/output unit 204 and a vehicle communication unit 205. The onboard terminal 200 can acquire a value outputted by the sensor 302 by performing communication with the vehicle platform 300.

The controller 201 is an arithmetic device that is responsible for control performed by the onboard terminal 200. The controller 201 can be realized by an arithmetic processing device such as a CPU (central processing unit).

The controller 201 is configured, including three function modules of a probe data acquisition unit 2011, a probe data transmission unit 2012 and a navigation unit 2013. These function modules may be realized by executing a program stored in a storage 202 described later by the CPU.

The probe data acquisition unit 2011 acquires data about a traveling environment of the vehicle (hereinafter, probe data). In the present embodiment, the probe data includes data indicating a flooding situation of a road surface. When the sensor 302 that the vehicle platform 300 includes is a sensor capable of directly sensing an amount of flooding on a road surface, the probe data may include an amount of flooding from a road surface (a water depth).

When the sensor 302 that the vehicle platform 300 includes is a sensor that indirectly senses an amount of flooding on a road surface, the probe data acquisition unit 2011 may estimate an amount of flooding based on data transmitted from the vehicle platform 300. For example, when the vehicle platform 300 is capable of acquiring data about a traveling resistance of the vehicle, it is possible to estimate an amount of flooding on a road surface by performing a predetermined operation for an acquired traveling resistance.

The probe data transmission unit 2012 periodically transmits sensing data acquired by the probe data acquisition unit 2011 to the server apparatus 100.

The navigation unit 2013 provides a navigation function for the driver of the vehicle. Specifically, the navigation unit 2013 performs provision of route guidance, provision of traffic information and the like. The navigation unit 2013 may include a unit for acquiring a current position of the vehicle (a GPS module or the like) and a unit for acquiring traffic information from outside (a communication module or the like).

Furthermore, the navigation unit 2013 outputs information about a traveling danger degree on a road based on information acquired from the server apparatus 100.

The storage 202 is configured, including a main memory and an auxiliary storage device. The main memory is a memory where a program executed by the controller 201 and data used by the control program are developed. The auxiliary storage device is a device in which the program executed by the controller 201 and the data used by the control program are stored. In the auxiliary storage device, what is obtained by packaging the program executed by the controller 201 as an application may be stored. An operating system for executing such an application may be stored. By the program stored in the auxiliary storage device being loaded to the main memory and executed by the controller 201, a process described hereinafter is performed.

Further, the storage 202 may store data for providing the navigation function (road map data) and the like.

The main memory may include a RAM (random access memory) and a ROM (read-only memory). The auxiliary storage device may include an EPROM (erasable programmable ROM) and an HDD (hard disk drive). Furthermore, the auxiliary storage device may include a removable medium, that is, a removable recording medium.

The communication unit 203 is a wireless communication interface for connecting the onboard terminal 200 to a network. The communication unit 203 is configured to be capable of communicating with the server apparatus 100, for example, via a mobile communication service such as a wireless LAN, 3G, LTE or 5G.

The input/output unit 204 is a unit that accepts an input operation performed by the user and presents information to the user. In the present embodiment, the input/output unit 204 is configured with one touch panel. That is, the input/output unit 204 is configured with a liquid crystal display and control therefor, and a touch panel and control therefor.

The vehicle communication unit 205 is an interface unit for performing communication with the vehicle platform 300. The vehicle communication unit 205 is configured to be capable of communicating with the ECU 301 that the vehicle platform 300 includes, via an onboard network.

Next, the server apparatus 100 will be described.

The server apparatus 100 can be configured with a general-purpose computer. That is, the server apparatus 100 can be configured as a computer that includes a processor such as a CPU and a GPU, a main memory such as a RAM and a ROM, an auxiliary storage device such as an EPROM, a hard disk drive and a removable medium. In the auxiliary storage device, an operating system (OS), various kinds of programs, various kinds of tables and the like are stored. By loading a program stored therein to a work area of the main memory, executing the program, and each of components and the like being controlled through the execution of the program, each of functions that meet predetermined purposes as described later can be realized. A part or all of the functions may be realized by a hardware circuit like an ASIC and an FPGA.

A controller 101 is an arithmetic device that is responsible for control performed by the server apparatus 100. The controller 101 can be realized by an arithmetic processing device such as a CPU.

The controller 101 is configured, including three function modules of a data acquisition unit 1011, a segment assignment unit 1012 and an information generation unit 1013. Each function module may be realized by executing a stored program by the CPU.

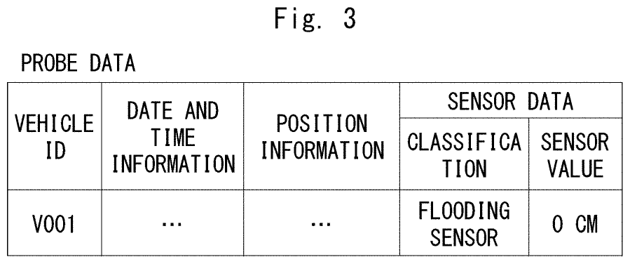

The data acquisition unit 1011 acquires probe data from the onboard terminals 200 mounted on the vehicles under the management of the system. FIG. 3 illustrates an example of probe data transmitted from an onboard terminal 200. As illustrated, the probe data includes an identifier (a vehicle ID) of the vehicle, information indicating a date and time when sensing was performed (date and time information), information indicating a point where the sensing was performed (position information) and sensor data. In this example, an amount of flooding on a road surface is a sensing target, and a value indicating a water depth is stored as a sensor value.

The segment assignment unit 1012 assigns each piece of probe data acquired by the data acquisition unit 1011 to a road segment. The server apparatus 100 in the present embodiment divides each road on which vehicles can travel into a plurality of road segments for management, and can associate a point corresponding to each piece of probe data (that is, a point where sensing has been performed) with a predetermined road segment.

Based on stored probe data, the information generation unit 1013 determines a traveling danger degree of a corresponding road segment, for each vehicle attribute.

A storage 102 is configured including a main memory and an auxiliary storage device. The main memory is a memory where a program executed by the controller 101 and data used by the control program are developed. The auxiliary storage device is a device in which the program executed by the controller 101 and the data used by the control program are stored.

Furthermore, the storage 102 stores a probe data table 102A, a danger degree table 102B and road segment data 102C.

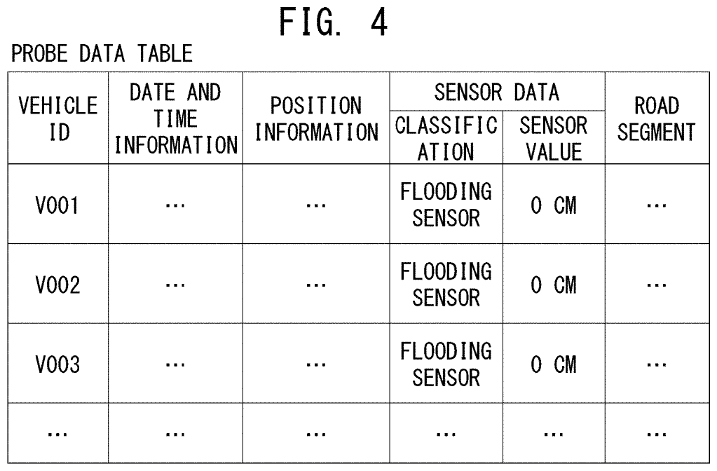

The probe data table 102A is a table that stores probe data received from the plurality of onboard terminals 200. FIG. 4 illustrates an example of the probe data table. As illustrated, pieces of probe data received from the individual onboard terminals 200 are added to the probe data table as separate records, respectively.

In a “road segment” field, an identifier of a road segment corresponding to a point where each piece of probe data has been generated is stored. Details will be described later.

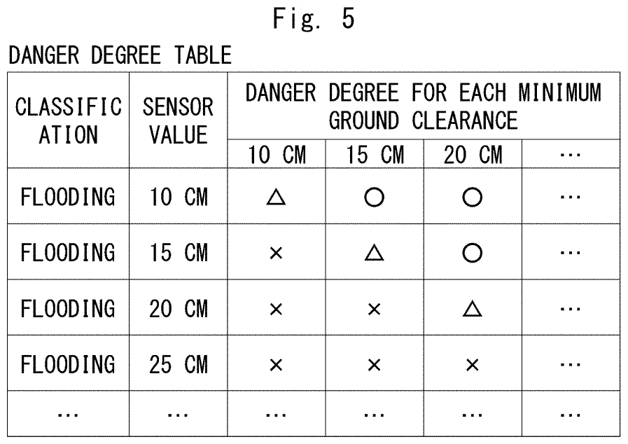

The danger degree table 102B is a table in which data for determining traveling danger degrees from sensor values (that is, amounts of flooding) sensed by the vehicles is stored. FIG. 5 illustrates an example of the traveling danger degree table.

As described before, a traveling danger degree at the time of a road being flooded differs according to vehicle classes or minimum ground clearances of vehicles. Therefore, by using the data as illustrated, a danger degree at the time of a vehicle including a particular vehicle class passing through a flooded road can be determined.

In this example, danger degrees corresponding to water depths are classified and defined according to each of vehicle classes (minimum ground clearances). In this example, it can be read that, for example, in the case of a water depth of 15 cm, a vehicle with a minimum ground clearance of 10 cm cannot pass through, and a vehicle with a minimum ground clearance of 20 cm can pass through.

Though the minimum ground clearance is used as a vehicle attribute in this example, other criteria can be also used.

The road segment data 102C is data that defines road segments.

The system according to the present embodiment divides each road on which vehicles can travel into a plurality of segments and decides a traveling danger degree for each segment. The road segment data 102C includes data for defining geographical positions of roads and road segments.

A communication unit 103 is a communication interface for connecting the server apparatus 100 to a network. The communication unit 103 is configured, for example, including a network interface board and a wireless communication module for wireless communication.

The configuration illustrated in FIG. 2 is a mere example, and all or a part of the illustrated functions may be executed with dedicatedly designed circuits. Further, storage and execution of the program may be performed by a combination of a main memory and an auxiliary storage device other than the illustrated combination.

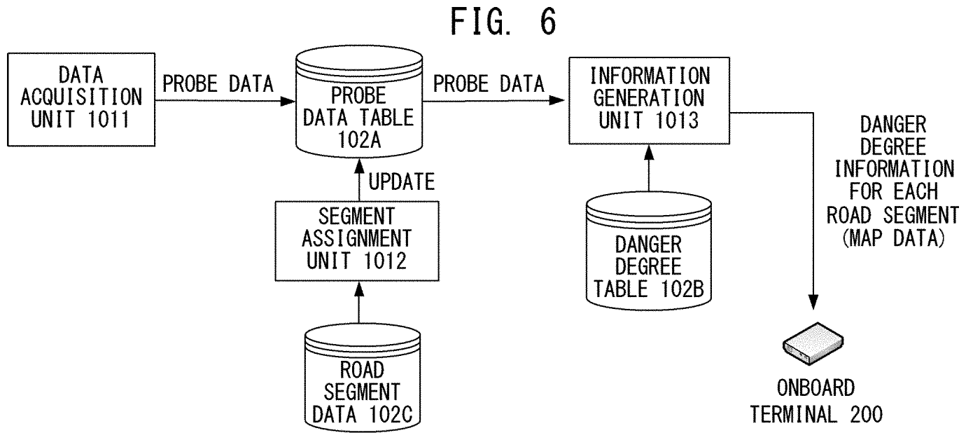

Details of a process performed by each module and used data will be described with reference to FIG. 6 which is a diagram illustrating data transmitted and received among the modules.

The data acquisition unit 1011 receives probe data from the onboard terminals 200 and stores the received probe data into the storage 102 (the probe data table 102A). Acquisition of the probe data is periodically executed for each of the plurality of onboard terminals 200 under the management.

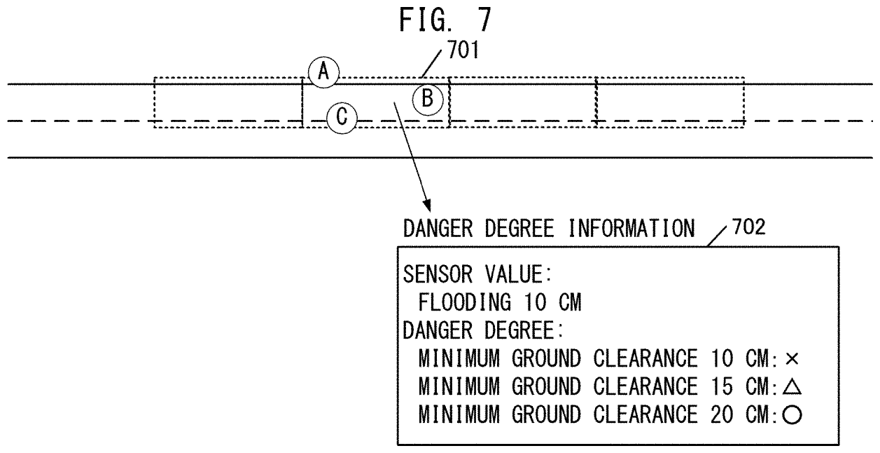

The segment assignment unit 1012 refers to the probe data table 102A and associates a point indicated by newly acquired probe data with a road segment. FIG. 7 is a diagram illustrating a relationship between points where probe data has been generated and a road segment. A plurality of areas surrounded by dotted lines indicates road segments. The segment assignment unit 1012 assigns pieces of probe data received by the apparatus to road segments defined in advance, respectively.

Circled letters in FIG. 7 indicate positions where probe data has been generated. For example, three pieces of probe data have been generated near a road segment 701. That is, at three points, a point indicated by a sign A, a point indicated by a sign B and a point indicated by a sign C, the pieces of probe data have been generated. The segment assignment unit 1012 assigns these plurality of pieces of probe data to a corresponding road segment (indicated by a sign 701 in FIG. 7).

The assignment result is reflected on the probe data table 102A. Specifically, the segment assignment unit 1012 stores the identifier of the assigned road segment into the “road segment” fields of corresponding records.

The information generation unit 1013 determines a traveling danger degree corresponding to a road segment for each vehicle attribute, based on probe data stored in the probe data table 102A and the danger degree table 102B. For example, information indicated by reference numeral 702 is generated for the road segment indicated by reference numeral 701 in FIG. 7.

When a plurality of pieces of probe data is associated with one road segment, a representative value of sensor values indicated by these pieces of probe data may be determined to determine a traveling danger degree based on the representative value. The representative value may be, for example, a value of the highest danger degree among the plurality of sensor values or an average value of the plurality of sensor values.

In the present embodiment, a set of a sensor value and information indicating a danger degree for each vehicle attribute in a particular road segment will be referred to as “danger degree information”.

The information generation unit 1013 generates data that includes information identifying positions of a plurality of road segments and pieces of danger degree information assigned to the plurality of road segments (hereinafter, map data).

Further, the information generation unit 1013 transmits the generated map data to each of the plurality of onboard terminals 200 in a predetermined cycle. The onboard terminals 200 can map danger degrees on a road map based on the received map data.

The information generation unit 1013 may perform a process for limiting a range at the time of transmitting the map data to the onboard terminals 200. For example, the information generation unit 1013 may extract a plurality of road segments near a target onboard terminal 200 (for example, in a range reachable within a predetermined period) and transmit map data that includes only pieces of danger degree information corresponding to the plurality of road segments, to the onboard terminal 200.

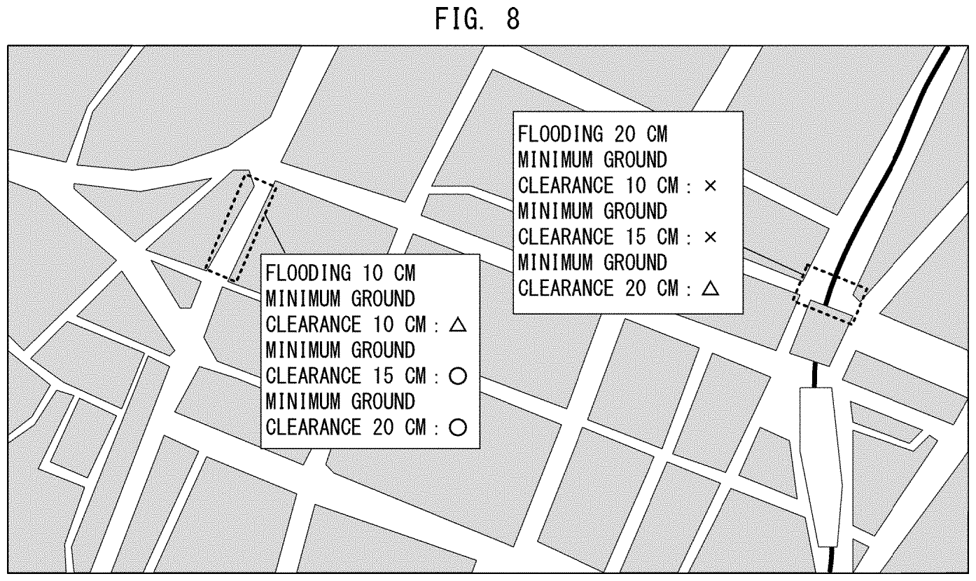

Each onboard terminal 200 (each navigation unit 2013) maps the pieces of danger degree information onto a road map based on the map data received from the server apparatus 100 and outputs the mapping result. FIG. 8 illustrates an example of a road map on which pieces of danger degree information are mapped. Though particular segments are surrounded by rectangles, and the pieces of danger degree information are presented using markup balloons, the pieces of danger degree information may be indicated in a method other than this. For example, a plurality of road segments may be color-coded according to danger degrees and outputted in a heat map form.

Further, each onboard terminal 200 may cause only danger degree information corresponding to an attribute (for example, a minimum ground clearance) of its own vehicle to be an output target.

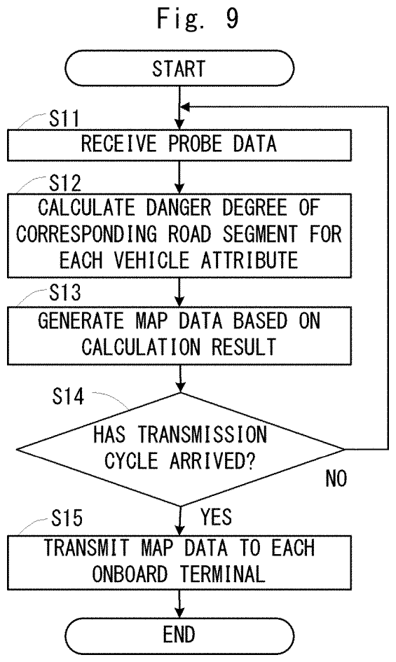

FIG. 9 is a flowchart illustrating a process executed by the server apparatus 100. The flowchart illustrated in FIG. 9 is periodically executed for each of the plurality of vehicles under the management (the onboard terminals 200) during operation of the system.

At step S11, the data acquisition unit 1011 receives pieces of probe data from the onboard terminals 200. The received pieces of probe data are reflected onto the probe data table 102A. The segment assignment unit 1012 assigns road segments corresponding to the pieces of probe data.

Next, at step S12, the information generation unit 1013 refers to the probe data table 102A and calculates a danger degree of each road segment for each vehicle attribute. At this step, the process may be performed only for pieces of probe data generated within a predetermined period (for example, within the past one hour) as targets.

At step S13, the information generation unit 1013 generates data in which generated pieces of danger degree information are assigned to the plurality of road segments (map data).

At step S14, for a target onboard terminal 200, it is decided whether a map data transmission cycle has arrived or not. When the transmission cycle has not arrived, the process transitions to step S11. When the transmission cycle has arrived, the process transitions to step S15, where a range corresponding to the target onboard terminal 200 is extracted from the generated map data and is transmitted to the onboard terminal 200.

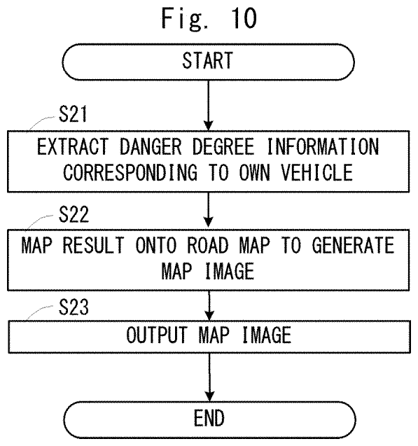

FIG. 10 is a flowchart of a process executed by the onboard terminal 200 that has received the map data. The illustrated process is executed by the navigation unit 2013 when the onboard terminal 200 receives the map data.

At step S21, among the pieces of danger degree information assigned to the plurality of road segments, the onboard terminal 200 extracts pieces of danger degree information corresponding to its own vehicle. For example, when the minimum ground clearance of its own vehicle is 10 cm, pieces of danger degree information corresponding to a vehicle with a minimum ground clearance of 10 cm are extracted.

At step S22, the extracted pieces of danger degree information are mapped onto a road map to generate a map image. At this step, for example, a color corresponding to a danger degree may be given to each road segment. At step S23, the generated map image is outputted via the input/output unit 204.

As described above, the server apparatus 100 according to the first embodiment calculates a traveling danger degree for each road segment, based on probe data received from the onboard terminals 200 and generates map data. Since the traveling danger degree is generated for each of attributes that the vehicles include, each onboard terminal 200 that has received the map data can present appropriate danger degree information corresponding to its own vehicle to the driver.

Though the server apparatus 100 transmits map data to the onboard terminals 200, and each onboard terminal 200 combines danger degree information and a road map in the present embodiment, the server apparatus 100 may combine the danger degree information and the road map. In this case, the server apparatus 100 may generate a map image corresponding to a current position of each onboard terminal 200.

Further, though flooding is exemplified as a factor that is dangerous to traveling of vehicles in the present embodiment, a sensing target may be other than flooding. For example, a degree of snow cover or road surface freezing may be sensed based on an output of an image sensor, a sensor for detecting road surface freezing, a slip detection sensor or the like mounted on a vehicle to calculate a degree of danger due to the snow cover or the road surface freezing for each vehicle attribute (for example, vehicle class, drive shaft, tire type or the like).

### Second Embodiment

In the first embodiment, probe data provides only a sensor value, and the server apparatus 100 decides a danger degree based on the sensor value. In comparison, a second embodiment is an embodiment in which probe data provides an attribute of a vehicle and data about a behavior that occurs on the vehicle.

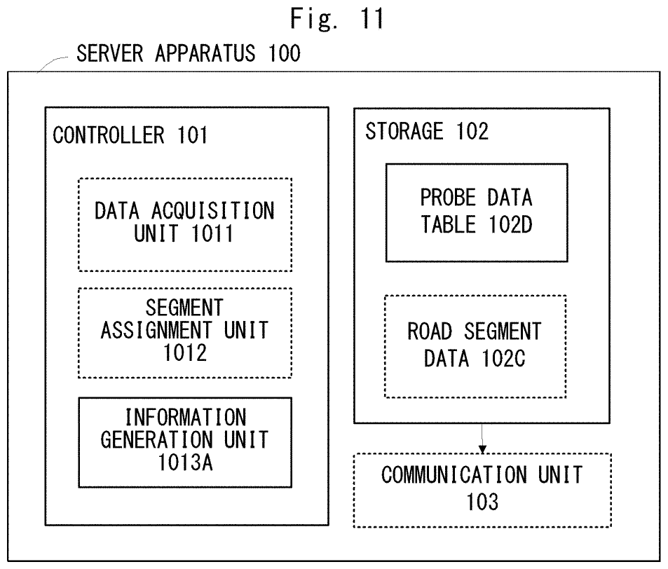

FIG. 11 is a system configuration diagram of the server apparatus 100 in the second embodiment. The second embodiment is different from the first embodiment in that a probe data table 102D includes data about “vehicle attribute” and “vehicle behavior”. Further, the second embodiment is different from the first embodiment in that an information generation unit 1013A decides a traveling danger degree based on the above data.

In the second embodiment, the danger degree table 102B is not used.

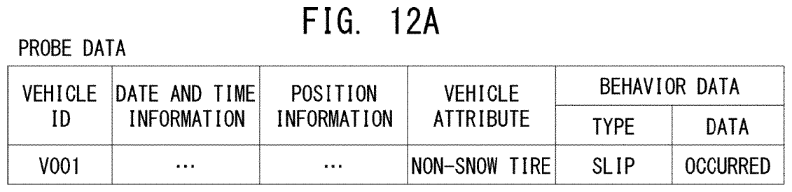

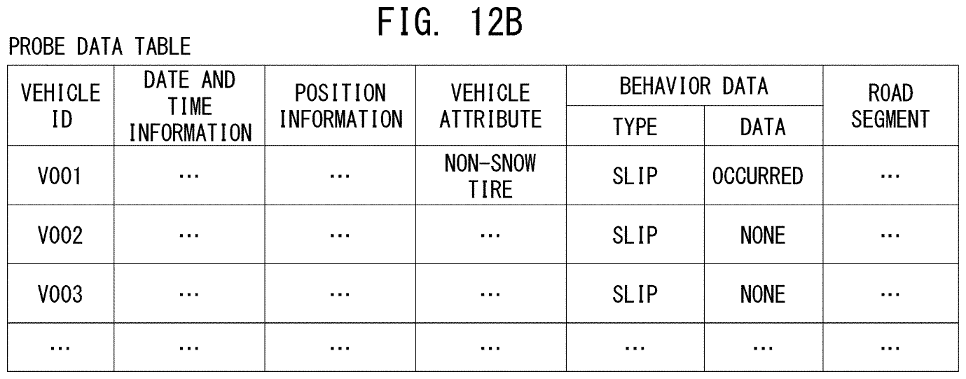

FIG. 12A illustrates an example of probe data transmitted from an onboard terminal 200 in the second embodiment. Further, FIG. 12B illustrates an example of a probe data table in the second embodiment.

As illustrated, in the present embodiment, the probe data includes “vehicle attribute” and “behavior data”.

The vehicle attribute is data indicating an attribute of a vehicle, and may be data about a vehicle class or size of the vehicle as described before or data indicating the type of equipped tires or the like.

The behavior data is data indicating a behavior that occurs on the vehicle. In the present embodiment, the behavior data indicates whether the vehicle has slipped or not.

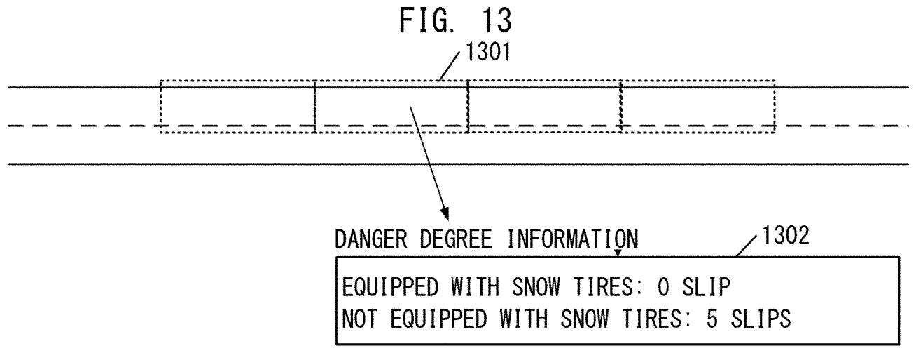

In the second embodiment, for each road segment, the information generation unit 1013A totalizes the number of vehicles that have exhibited a predetermined behavior for each vehicle attribute. In the example of FIG. 13, it is illustrated that five slips occurred in a predetermined period in the past on a road segment indicated by reference numeral 1301, and none of the vehicles were equipped with snow tires.

A map data generation method is similar to that of the first embodiment.

Further, in the present embodiment, each onboard terminal 200 extracts and outputs danger degree information suitable for the type of tires of its own vehicle from map data at step S21.

According to the second embodiment, it is possible to decide a danger degree on a road based on behaviors exhibited by vehicles.

### Modification of Second Embodiment

In the second embodiment, a traveling danger degree is decided for each vehicle attribute. On the other hand, there may be a case where a particular behavior (a slip or the like) occurs on a vehicle due to a particular driving operation (for example, sudden steering). Therefore, a traveling danger degree may be decided based on a performed driving operation instead of (or in addition to) a vehicle attribute. Therefore, for example, information about a driving operation performed within a predetermined period may be included in probe data. Then, the server apparatus 100 may decide a traveling danger degree based on the driving operation and generate map data.

Thereby, for example, “a location that is dangerous when a sudden driving operation is performed” can be visualized.

### Third Embodiment

Though danger degree information is generated for each road segment in the first and second embodiments, flooding and the like due to torrential rain may influence a wide range. In order to visualize this, the server apparatus 100 may generate data informing an area not to be entered (hereinafter, a dangerous area) based on the danger degree information generated for each road segment. The area not to be entered can be, for example, such an area in which a road segment with a danger degree exceeding a predetermined value is included (or exists nearby). This is because it is predicted that, when a vehicle enters such an area, progress becomes difficult on the way in some cases.

In the third embodiment, the server apparatus 100 identifies a dangerous area based on the danger degree information generated for each road segment and generates data indicating a geographical position of the dangerous area (hereinafter, area data). The area data can be generated for each vehicle attribute.

In the third embodiment, the server apparatus 100 transmits the area data generated for each vehicle attribute to each onboard terminal 200, and the onboard terminal 200 generates a guidance for the driver of its own vehicle using area data suitable for the attribute of its own vehicle. Thereby, for example, “an area that a vehicle with a minimum ground clearance of 10 cm should not enter” can be visualized.

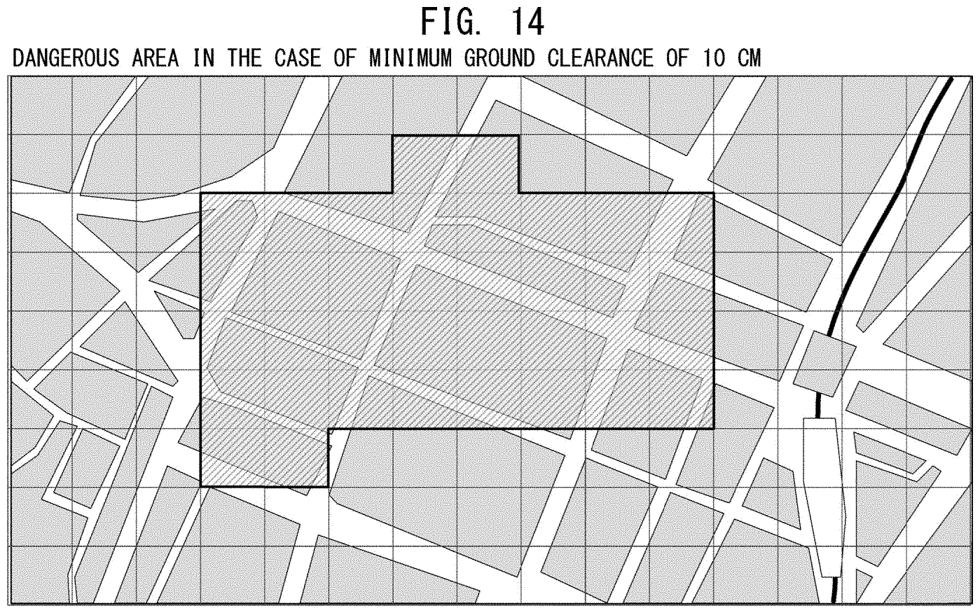

FIG. 14 illustrates an example of mapping a decided dangerous area on a road map.

Thus, according to the third embodiment, it is possible to visualize an area not to be entered, for each vehicle attribute.

The server apparatus 100 may estimate occurrence of a dangerous area in the near future based on transition of danger degree information for each road segment generated in the past. Thereby, for example, it becomes possible to provide information such as “a dangerous area predicted to occur within an hour” for drivers of vehicles.

### Fourth Embodiment

When a dangerous area occurs, there may be a case where a surrounding area is crowded with vehicles that bypass the dangerous area. Therefore, information about an area that is crowded by being influenced by a dangerous area (hereinafter, an influenced area) may be presented to drivers of vehicles.

In the fourth embodiment, the server apparatus 100 is caused to include information about “how much traffic amount there is usually in a dangerous area” so that the server apparatus 100 decides how many vehicles that are influenced by the dangerous area (bypassing vehicles) there will be.

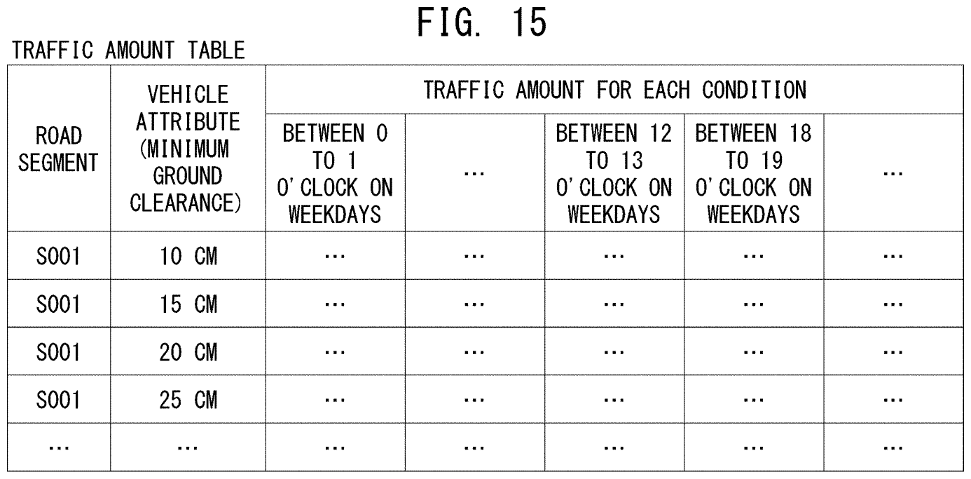

In the fourth embodiment, the server apparatus 100 stores traffic amount data for each road segment and for each vehicle attribute. FIG. 15 illustrates an example of a table that stores traffic amount data. Though a traffic amount for each time zone is exemplified in this example, the traffic amount data may include other conditions.

Further, when a dangerous area occurs, the server apparatus 100 decides how much traffic amount that is influenced by the dangerous area will occur. For example, when such a dangerous area that vehicles with a minimum ground clearance of 10 cm are influenced occurs, a usual traffic amount for vehicles with the minimum ground clearance of 10 cm in the area is acquired. The vehicles are to be vehicles influenced by the dangerous area.

Furthermore, assuming that the vehicles will bypass the dangerous area, the server apparatus 100 decides a traffic amount of the bypassing vehicles. Around the dangerous area, increase in a traffic amount due to the bypassing vehicles is anticipated. Therefore, by estimating a route on which the bypassing vehicles will travel, it is possible to estimate an area influenced by the bypassing vehicles (for example, an area where a traffic jam occurs) (an influenced area).

In the fourth embodiment, the server apparatus 100 transmits information about an estimated influenced area to the onboard terminals 200, and the onboard terminals 200 output the information. Thereby, smooth traffic can be realized.

Data about directions or destinations of vehicles may be included in the traffic amount data. Thereby, it is possible to decide routes taken by the bypassing vehicles more accurately.

### Modification

The above embodiments are mere examples, and the present disclosure can be appropriately changed and implemented within a range not departing from its spirit.

For example, the processes and means described in the present disclosure can be freely combined and implemented as far as technical inconsistency does not occur.

Further, though probe data transmitted from vehicles is exemplified in the description of the embodiments, a traveling danger degree may be decided based on other information. For example, it is also possible to estimate traveling environments of vehicles at an arbitrary point, based on weather information, snowplow schedules, information from rain cloud radars, and the like.

Further, a process described as being performed by one apparatus may be shared and executed by a plurality of apparatuses. Or alternatively, processes described as being performed by different apparatuses may be executed by one apparatus. In a computer system, what hardware configuration (server configuration) each function is realized by can be flexibly changed.

The present disclosure can be realized by supplying a computer program in which the functions described in the above embodiments are implemented to a computer, and one or more processors that the computer includes reading out and executing the program. Such a computer program may be provided to the computer by a non-transitory computer-readable storage medium connectable to a system bus of the computer or may be provided to the computer via a network. The non-transitory computer-readable storage medium includes, for example, a disk of an arbitrary type such as a magnetic disk (a floppy (registered trademark) disk, a hard disk drive (HDD) and the like) and an optical disk (a CD-ROM, a DVD disc, a Blu-ray disc and the like), a read-only memory (ROM), a random-access memory (RAM), an EPROM, an EEPROM, a magnetic card, a flash memory, an optical card, and a medium of an arbitrary type that is appropriate for storing electronic commands.

What is claimed is:

1. An information processing apparatus comprising a controller comprising at least one processor, the controller being configured to execute:
receiving pieces of probe data from a plurality of vehicles having traveled through a predetermined point, each of the pieces of probe data indicating a traveling environment at the point; and
generating information for other vehicles to pass through the point, for each of attributes of vehicles, based on the pieces of probe data.

2. The information processing apparatus according to claim 1, further comprising a storage storing data defining a plurality of road segments, wherein the controller generates the information for each of the plurality of road segments based on the pieces of probe data generated at a point corresponding to each of the plurality of road segments.

3. The information processing apparatus according to claim 1, wherein the controller determines a traveling danger degree corresponding to each of the attributes of the vehicles as the information.

4. The information processing apparatus according to claim 3, wherein
each of the pieces of probe data includes data about a degree of flooding at the point; and
the controller determines the traveling danger degree based on the degree of the flooding.

5. The information processing apparatus according to claim 3, wherein
the attributes are vehicle classes or minimum ground clearances of the vehicles; and
the controller determines the traveling danger degree for each of the vehicle classes or minimum ground clearances of the vehicles.

6. The information processing apparatus according to claim 3, wherein
each of the pieces of probe data includes data about a degree of snow cover or road surface freezing at the point; and
the controller determines the traveling danger degree based on the degree of the snow cover or road surface freezing.

7. The information processing apparatus according to claim 6, wherein
the attributes are types of tires that the vehicles include; and
the controller determines the traveling danger degree for each of the types of the tires that the vehicles include.

8. The information processing apparatus according to claim 3, wherein the controller decides a first area, which is an area where a traveling danger degree in a case of a vehicle with a predetermined attribute passing through the area exceeds a threshold, and maps the first area onto a road map.

9. The information processing apparatus according to claim 3, wherein the controller predicts occurrence of a first area, which is an area where a traveling danger degree in a case of a vehicle with a predetermined attribute passing through the area exceeds a threshold, and maps the predicted first area onto a road map.

10. The information processing apparatus according to claim 8, wherein the controller further maps a second area, which is an area to be influenced by vehicles bypassing the first area, onto the road map.

11. The information processing apparatus according to claim 10, wherein the controller
further acquires data about a traffic flow of passage through the first area in a past and
generates a bypass route based on the past traffic flow.

12. The information processing apparatus according to claim 3, wherein
the pieces of probe data include pieces of information about the attributes of the vehicles and pieces of information about particular behaviors that have occurred on the vehicles; and
the controller determines the traveling danger degree in a case of a plurality of vehicles with different attributes passing through the point, for each of the attributes.

13. The information processing apparatus according to claim 12, wherein
the particular behaviors are slips; and
the attributes are types of tires that the vehicles include.

14. The information processing apparatus according to claim 3, wherein
the pieces of probe data include pieces of information about driving operations performed for the vehicles and pieces of information about behaviors that have occurred due to the driving operations; and
the controller determines a traveling danger degree in a case of a particular driving operation being performed.

15. An information processing system comprising an information processing apparatus and a plurality of onboard apparatuses, wherein
each of the plurality of onboard apparatuses comprises a first controller comprising at least one processor, the first controller being configured to execute:
generating probe data indicating a traveling environment at a predetermined point;
transmitting the probe data to the information processing apparatus; and
receiving map data including traveling-related information from the information processing apparatus and outputting the map data, and
the information processing apparatus comprises a second controller comprising at least one processor, the second controller being configured to execute:
receiving the probe data from each of the plurality of onboard apparatuses;
generating information for other vehicles to pass through the point, for each of attributes of vehicles, based on the probe data;
generating the map data based on the information generated for a plurality of points; and
transmitting the map data to the plurality of onboard apparatuses.

16. The information processing system according to claim 15, wherein
the second controller generates the map data for each of the attributes that the vehicles include; and
the first controller causes the map data corresponding to an attribute of its own vehicle to be an output target.

17. The information processing system according to claim 15, wherein the second controller decides a first area, which is an area where a traveling danger degree in a case of a vehicle with a predetermined attribute passing through the area exceeds a threshold, and generates the map data indicating the first area.

18. The information processing system according to claim 15, wherein the second controller predicts occurrence of a first area, which is an area where a traveling danger degree in a case of a vehicle with a predetermined attribute passing through the area exceeds a threshold, and generates the map data indicating the predicted first area.

19. An information processing method comprising:
receiving pieces of probe data from a plurality of vehicles having traveled through a predetermined point, each of the pieces of probe data indicating a traveling environment at the point; and
generating information for other vehicles to pass through the point, for each of attributes of vehicles, based on the pieces of probe data.

20. A non-transitory storage medium storing a program for causing a computer to execute the information processing method according to claim 19.
